(19) United States
(12) Patent Application Publication
(10) Pub. No.: US 2026/0117974 A1
(43) Pub. Date: Apr. 30, 2026

(54) SYSTEMS AND METHODS FOR FLAME MONITORING IN GAS-POWERED APPLIANCES

(71) Applicant: Copeland Comfort Control LP, St. Louis, MO (US)

(72) Inventor: Richard Brower, St. Louis, MO (US)

(21) Appl. No.: 19/312,081

(22) Filed: Aug. 27, 2025

Related U.S. Application Data
(60) Provisional application No. 63/713,791, filed on Oct. 30, 2024.

(51) Int. Cl. F23N 5/12; G01N 27/04

(52) U.S. Cl. CPC F23N 5/123; G01N 27/04; F23N 2223/04; F23N 2223/08; F23N 2229/12; F23N 2229/22

(57) ABSTRACT

A gas-powered appliance includes a main burner for burning gas, a flame sensor assembly, and a controller. The flame sensor assembly includes a probe positioned proximate the main burner and a detector coupled to the probe to receive an alternating current (AC) input, couple the AC input to the probe and generate a variable pulse width direct current (DC) square wave output having a plurality of pulses. The controller connected is to the flame sensor assembly and includes a processor and a memory. The controller is programmed to control the main burner to burn gas, determine a pulse width of a pulse of the DC square wave, and determine based on the determined pulse width a characteristic of the flame on the main burner with greater precision than some known systems.

### CROSS REFERENCE TO RELATED APPLICATIONS

This application claims priority to U.S. Provisional Patent Application No. 63/713,791, filed Oct. 30, 2024, the disclosure of which is hereby incorporated by reference in its entirety.

### FIELD

The field of the disclosure relates generally to gas-powered appliances, and more particularly, to systems and methods for flame monitoring in a gas-powered appliance.

### BACKGROUND

Gas-powered appliances (such as a gas-powered furnace, a gas-powered oven, a gas-powered water heater, and the like) include a burner at which gas is burned. Such appliances typically include a flame sensor to detect when a flame is present on the gas-powered burner, so that gas is not emitted from the burner for extended periods of time when a flame is not present.

In at least some gas-powered appliances, the flame sensor includes one or more electrodes positioned near the location of the expected flame from the gas-powered burner. A voltage is applied to one of the electrodes. When no flame is present, there is no path for current from the electrode to which the voltage is applied, and no current flows from the electrode. When a flame is present on the burner, current will pass through the ionized gases of the flame from the electrode (e.g., to another electrode, to ground, to the burner, or the like). By monitoring for the presence or absence of this current (sometimes referred to as a flame current), the gas-powered appliance can determine if a flame is present on the burner.

Moreover, the amount of current that will flow from the electrode varies somewhat depending on the strength of the flame. That is, a small or spluttering flame will allow less current to flow than a strong, normal flame. The flame current typically will have both a DC and an AC component. The DC portion of the current is typically used to indicate flame strength. Thus, at least some gas-powered appliances attempt to monitor the value of the DC current to estimate the strength of the flame. Because the current flowing from the electrode and through the flame is very small (the DC portion is typically less than ten microamps DC), such strength estimation is typically very coarse, providing only three levels: strong flame, weak flame, and no flame. Often the weak flame level is very close to the no flame level so not much warning time is available, once the weak flame level is reached, there is not much decrease in current until the flame will not be able to be detected and a no flame condition will exist and the appliance will not be able to provide function.

Because the flame sensor electrode is present in the combustion chamber near the flame of the gas-powered appliance, the electrode typically becomes coated with deposits from the combustion. These deposits insulate the electrode, thereby reducing the current that can flow from the electrode. Thus, the amount of current flowing from the electrode may also be an indication of the condition of the electrode of the flame sensor. That is, a low current may indicate a weak flame, a dirty sensor electrode, or both.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

According to one aspect of this disclosure, a gas-powered furnace system includes a combustion chamber for generating heat from combustion of gas, a main burner for burning gas disposed in the combustion chamber, a flame sensor assembly, and a controller connected to the flame sensor assembly. The flame sensor assembly includes a probe positioned proximate the main burner to couple an electric current to the main burner through a flame on the main burner and not to couple an electric current to the main burner when the flame is not present on the main burner, and a detector coupled to the probe, the detector configured to receive an alternating current (AC) input, couple the AC input to the probe, and generate a direct current (DC) square wave output having a variable pulse width. The controller includes a processor and a memory. The controller is programmed to control the main burner to selectively burn gas, determine a pulse width of a pulse of the DC square wave, and determine based on the determined pulse width a characteristic of the flame on the main burner with greater precision than some known systems.

Another aspect of the disclosure is a gas-powered appliance includes a main burner for burning gas, a flame sensor assembly, and a controller. The flame sensor assembly includes a probe positioned proximate the main burner and a detector coupled to the probe to receive an alternating current (AC) input, couple the AC input to the probe and generate a direct current (DC) square wave output having a variable pulse width. The controller connected is to the flame sensor assembly and includes a processor and a memory. The controller is programmed to control the main burner to burn gas, determine a pulse width of a pulse of the DC square wave, and determine based on the determined pulse width a characteristic of the flame on the main burner with greater precision than some known systems.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The following figures illustrate various aspects of the disclosure.

FIG. 1 is a schematic diagram of a gas furnace system including a furnace control system.

FIG. 2 is a block diagram of a computing device for use in the furnace system shown in FIG. 1.

FIG. 3 is a block diagram of a portion of the furnace shown in FIG. 1 including a flame sensor assembly.

FIG. 4 is a circuit diagram of an embodiment of the flame detector in FIG. 3.

FIG. 5 is a graph of a simulated AC input and DC square wave output of the detector in FIG. 4 when there is no flame.

FIG. 6 is a graph of a simulated AC input and DC square wave output of the detector in FIG. 4 when there is a flame present.

Corresponding reference characters indicate corresponding parts throughout the drawings.

### DETAILED DESCRIPTION

For conciseness, examples will be described with respect to a gas-powered furnace. However, the methods and systems described herein may be applied to any suitable gas-powered appliance, including without limitation a gas-powered dryer, a gas-powered water heater, or a gas-powered oven.

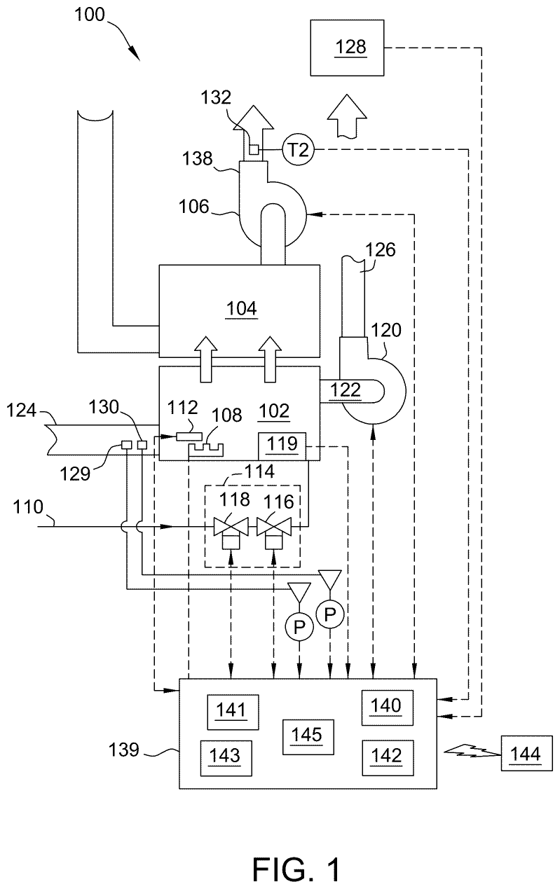

Referring initially to FIG. 1, a gas furnace system of one embodiment for heating a temperature controlled environment is indicated generally at 100. The gas furnace system 100 generally includes a combustion chamber 102 for generating heat from combustible gases, a heat exchanger 104, and an air circulator 106 for circulating fluid (e.g., air) past the heat exchanger 104 to transfer heat generated by the combustion chamber 102 to the circulating fluid.

The combustion chamber 102 includes a main burner 108 connected to a gas fuel supply (not shown) via a gas inlet 110, and an ignition device 112, such as a hot surface ignitor, a spark ignitor, an intermittent pilot, or the like configured to ignite an air/fuel mixture within the combustion chamber 102. The burner 108 includes one or more burners through which fuel gas is fed. The supply of fuel gas to the burner 108 is controlled by a gas valve assembly 114, which, in the illustrated embodiment, includes a main burner valve 116 and a safety valve 118. In embodiments in which the ignition device 112 is an intermittent pilot, a supply of fuel gas to the intermittent pilot is controlled by a pilot gas valve (not shown). A flame probe 119 (also sometimes referred to as a flame sensor) is positioned near the burner 108 for use detecting the presence or absence of a flame produced by the burner 108 and other characteristics of the produced flame.

An inducer blower 120 (also referred to as a draft inducer) is connected to the combustion chamber 102 by a blower inlet 122. The inducer blower 120 is configured to draw fresh (i.e., uncombusted) air into the combustion chamber 102 through an air inlet 124 to mix fuel gas with air to provide a combustible air/fuel mixture. The inducer blower 120 is also configured to force exhaust gases out of the combustion chamber 102 and vent the exhaust gases to atmosphere through an exhaust outlet 126. The inducer blower 120 includes a motor (not shown), that drives a fan, impeller, or the like to move air.

The combustion chamber 102 is fluidly connected to the heat exchanger 104. Combusted gases from the combustion chamber 102 are circulated through the heat exchanger 104 while the air circulator 106 forces air from the temperature controlled environment into contact with the heat exchanger 104 to exchange heat between the heat exchanger 104 and the temperature controlled environment. The air circulator 106 subsequently forces the air through an outlet 138 and back into the temperature controlled environment.

The operation of the system 100 is generally controlled by a furnace control system 139, which includes a safety system 140, a fan control 142, a processor 141, a memory 143, a spark ignition controller 145, each of which may be a separate controller or one or more of which may be embodied in a single controller. A thermostat 128 is connected to the furnace control system 139. Other embodiments may use hot surface ignition or a standing pilot rather than direct spark ignition using a spark ignition controller. The thermostat 128 is connected to one or more temperature sensors (not shown) for measuring the temperature of the temperature controlled environment. The furnace control system 139 is connected to each of the gas valve assembly 114, the ignition device 112, the inducer blower 120, and the air circulator 106 for controlling operation of the components in response to control signals received from the thermostat 128. Generally, the fan control 142 controls operation of the air circulator 106 and inducer blower 120, and the safety system 140 monitors and protects against safety failures (such as failure of ignition during an attempt to light gas at the burner 108). The spark ignition controller 145 controls the main gas valve, the pilot gas valve (if applicable), and the ignition device 112 to ignite gas at the burner 108 when desired. The furnace control system 139 is communicatively connected to the flame probe 119 that detects whether or not a flame has been ignited on the burner 108 and/or on an intermittent pilot (where applicable). In some embodiments, the flame probe 119 is communicatively connected to the spark ignition controller 145. Moreover, in some embodiments, one or both of the safety system 140 and the fan control 142 are integrated with the spark ignition controller 145. In still other embodiments, the spark ignition controller 145 functions are performed by the furnace control system 139 without a separate spark ignition controller 145. A mobile device 144, such as a mobile phone, a tablet computing device, a laptop computing device, a smart watch, or the like, may be used for wireless communication with the furnace control system 139 and/or the spark ignition controller 145. Other embodiments are not configured for communication with a mobile device 144.

The processor 141 is configured for executing instructions to cause the furnace control system 139 to perform as described herein. In some embodiments, executable instructions are stored in the memory 143. The processor 141 may include one or more processing units (e.g., in a multi-core configuration). The memory 143 is any non-transitory storage device allowing information such as executable instructions and/or other data to be stored and retrieved. The memory 143 may include one or more computer-readable media. The memory 143 stores computer-readable instructions for control of the system 100 as described herein. The methods described herein may be encoded as executable instructions embodied in a computer-readable medium including, without limitation, memory 143 or any other storage device and/or memory device. Such instructions, when executed by a processor, cause the processor to perform at least a portion of the methods described herein.

The term processor, as used herein, refers to central processing units (CPU), microprocessors, microcontrollers, reduced instruction set circuits (RISC), application specific integrated circuits (ASIC), programmable logic circuits (PLC), logic circuits, and any other circuit or processor capable of executing the functions described herein. The above are examples only, and are thus not intended to limit in any way the definition and/or meaning of the term “processor.”

The term memory, as used herein, may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of data, instructions, and/or a computer program.

The example system 100 includes a plurality of sensors and detectors for monitoring the environmental and operating conditions of the system 100. The illustrated furnace system includes a pressure transducer 129, a pressure switch 130, and a temperature sensor 132. The furnace control system 139 is connected to each of the pressure transducer 129, the pressure switch 130, and the temperature sensor 132 and is configured to control the furnace system 100 based at least in part on signals received from the sensors and detectors. Other embodiments include more or fewer sensors/detectors. Some specific embodiments do not include the pressure switch 130 and include only the pressure transducer 129.

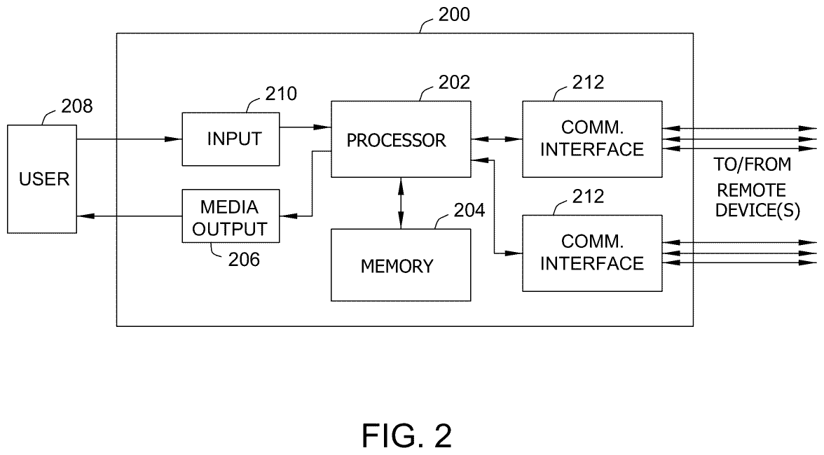

FIG. 2 is an example configuration of a computing device-based controller 200 for use as the entire control system 139 or one or more of the safety system 140, fan control 142, a spark ignition controller 145, and the processor 141 and memory 143. The controller 200 includes a processor 202, a memory 204, a media output component 206, an input device 210, and communications interfaces 212. Other embodiments include different components, additional components, and/or do not include all components shown in FIG. 2.

The processor 202 is configured for executing instructions. In some embodiments, executable instructions are stored in the memory 204. The processor 202 may include one or more processing units (e.g., in a multi-core configuration). The memory 204 is any device allowing information such as executable instructions and/or other data to be stored and retrieved. The memory 204 may include one or more computer-readable media.

The media output component 206 is configured for presenting information to user 208. The media output component 206 is any component capable of conveying information to the user 208. In some embodiments, the media output component 206 includes an output adapter such as a video adapter and/or an audio adapter. The output adapter is operatively connected to the processor 202 and operatively connectable to an output device such as a display device (e.g., a liquid crystal display (LCD), organic light emitting diode (OLED) display, cathode ray tube (CRT), “electronic ink” display, one or more light emitting diodes (LEDs)) or an audio output device (e.g., a speaker or headphones).

In an example embodiment, the media output 206 is connected to a display device (not shown) on the gas furnace system that displays an indication of the strength of the flame produced by the burner 108, as detected by the flame probe 119. In some embodiments, the display device is a display on the thermostat 128.

The controller 200 includes, or is connected to, the input device 210 for receiving input from the user 208. The input device is any device that permits the controller 200 to receive analog and/or digital commands, instructions, or other inputs from the user 208, including visual, audio, touch, button presses, stylus taps, etc. The input device 210 may include, for example, a variable resistor, an input dial, a keyboard/keypad, a pointing device, a mouse, a stylus, a touch sensitive panel (e.g., a touch pad or a touch screen), a gyroscope, an accelerometer, a position detector, or an audio input device. A single component such as a touch screen may function as both an output device of the media output component 206 and the input device 210. Some embodiments do not include any input devices 210 for receiving input from the user 208 and receive input from the user 208 from other inputs, such as through communication interfaces 212.

The communication interfaces 212 enable the controller 200 to communicate with remote devices and systems, such as mobile device 144, sensors, valve control systems, safety systems, remote computing devices, and the like. The communication interfaces 212 may be wired or wireless communications interfaces that permit the computing device to communicate with the remote devices and systems directly or via a network. Wireless communication interfaces 212 may include a radio frequency (RF) transceiver, a Bluetooth® adapter, a Wi-Fi transceiver, a ZigBee® transceiver, a near field communication (NFC) transceiver, an infrared (IR) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California.) Wired communication interfaces 212 may use any suitable wired communication protocol for direct communication including, without limitation, USB, RS232, I2C, SPI, analog, and proprietary I/O protocols. In some embodiments, the wired communication interfaces 212 include a wired network adapter allowing the computing device to be coupled to a network, such as the Internet, a local area network (LAN), a wide area network (WAN), a mesh network, and/or any other network to communicate with remote devices and systems via the network.

The memory 204 stores computer-readable instructions for control of the gas furnace system 100 as described herein. In some embodiments, the memory area stores computer-readable instructions for providing a user interface to the user 208 via media output component 206 and, receiving and processing input from input device 210.

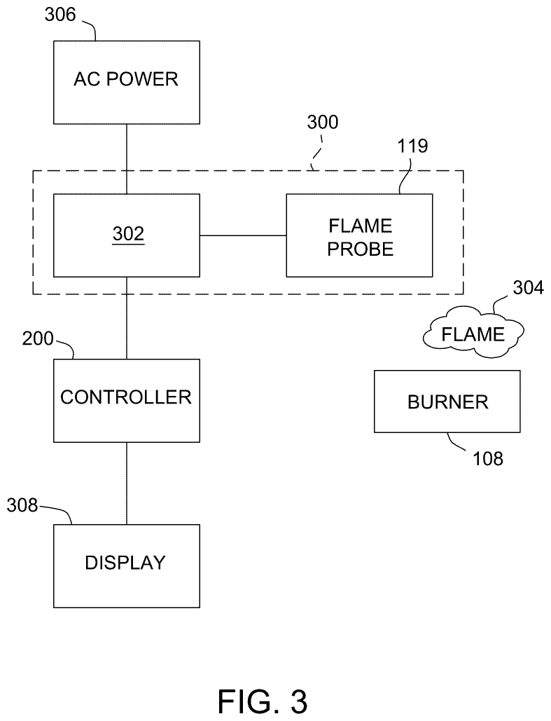

FIG. 3 is a block diagram of a portion of the gas furnace system 100 including a flame sensor assembly 300. The flame sensor assembly 300 includes the flame probe 119 and a detector 302 coupled to the flame probe 119. The detector 302 and the controller 200 form at least part of the furnace control system 139, and the controller 200 will generally control the main burner 108 to burn gas.

The flame probe 119 is positioned proximate the burner 108 to couple an electric current to the burner 108 through a flame 304 on the burner 108 and not to couple an electric current to the burner 108 when the flame is not present on the burner 108. That is, when flame 304 is not present (e.g., because furnace is not operating to produce heat or because flame 304 has not been ignited on the burner 108 because of a failure), an open circuit exists between the flame probe 119 and the burner 108. When the flame 304 exists, the flame (and the ionized gases around the flame) close the circuit between the burner 108 and the flame probe 119, thereby allowing a small electrical current from AC power source 306 to flow from the flame probe 119 to the burner 108. The amount of current flowing can depend on a number of factors, including how strong the flame is, the condition of the probe 119, the quality of the burn, the flickering of the flame (causing the flame to change its position relative to the probe) or the like. In some embodiments, the electrical current also includes a DC component.

The detector 302 receives the AC voltage from the AC power source 306 as an AC input and couples the AC input to the probe 119. The detector 302 generates a direct current (DC) square wave output to the controller 200. The DC square wave is a train of pulses of variable pulse width. In the example, embodiment, one pulse is generated for each cycle of the AC input. Other embodiments may have more or fewer pulses per AC input cycle.

The pulse width of the pulses generated by the detector 302 vary based on the characteristics of the flame. As used herein, the characteristics of the flame can include characteristics of the flame itself, characteristics of the probe 119, and other characteristics of the gas appliance that affect the flame. Characteristics of the flame itself can include for example whether or not the flame is present, the strength/intensity of the flame, the occurrence of an ignition event, flickering of the flame, and the content of the flame (e.g., the amount of unburnt gas, the amount of soot, the amount of carbon dioxide/carbon monoxide, and the like). The condition of the probe 119 can also affect the current coupled to the flame. A new, clean probe will typically be a better current conductor than and older, dirtier probe. The ventilation or lack of ventilation in the gas appliance is a characteristic of the gas appliance that can affect the flame by potentially causing excessive flickering and creating an excess or shortage of air compared to gas for combustion.

While known flame monitoring systems often provide an arbitrary analog measurement of flame current, the detector 302 generates a digital like signal that provides continuous feedback on the flame and the gas appliance. The output signals are digital like in that they switch between a minimum/low/“zero” value (that may be any relatively constant voltage and may actually be zero volts) and a maximum/high/“one” value (that may be any relatively constant voltage).

The DC square wave output by the detector 302 is input to the controller 200. The controller 200 determines the pulse width of each pulse of the DC square wave. The pulse width, that is the time from one signal edge or state transition (such as a rising/falling edge) to a next signal edge or state transition (such as a falling/rising edge, is a variable of interest for determining the characteristics of the flame. Moreover, the variation of the pulse width between different pulses can provide information about the characteristics of the flame, and in some embodiments the controller stores the determined pulse widths in memory. The pulse width variation may be useful in detecting that something has changed in the system, such as the probe 119 deteriorating, changes in the efficiency of combustion, or the like.

Based at least in part on the determined pulse width, the controller 200 determines a characteristic of the flame 304 on the main burner 108.

As discussed above, the characteristics of the flame can include characteristics of the flame itself, characteristics of the probe 119, and other characteristics of the gas appliance that affect the flame.

In some embodiments, the controller 200 then controls the main burner 108 based at least in part on the determined characteristic of the flame 304 on the main burner 108. For example, if the characteristic to be determined is the presence or absence of the flame 304, the controller 200 may attempt to ignite the flame 304 on the main burner when the determined characteristic is the absence of the flame 304 and the presence of the flame 304 is desired. Similarly, the controller may control the burner 108 to shut off the flame 304 when the flame 304 is detected to be present, but is not desired. When the characteristic being determined relates to the quality of the flame (e.g., whether too much gas or too much air is present in the combustion), the controller 200 may adjust the main burner valve 116 or other control components to improve the quality of the flame.

In some embodiments, the controller 200 may additionally or alternatively output information based on the determined characteristic of the flame 304 on the main burner 108. The information may include an indication of what the characteristic determined by the controller was, may include a value (whether absolute or relative) associated with the characteristic, may include a recommended action to be taken (e.g., “the flame probe is degraded and should be replaced”), the pulse width(s) determined by the controller 200, or any other information related to the determined characteristic of the flame.

The controller 200 may output the information on a display device 308 coupled to the controller 200, may output the information on an audio output device (not shown), and/or may output the information to a remote device using, for example, communication interface 212. The display device may be a liquid crystal display (LCD), organic light emitting diode (OLED) display, cathode ray tube (CRT), “electronic ink” display, one or more light emitting diodes (LEDs) or any other suitable device for displaying information to a user. The audio output device may be a speaker, headphones, or any other suitable device for providing audible information to a user. The communication to a remote device may be wired or wireless communication and may be direct communication between the controller and the remote device or may be indirect communication through a network, such as the Internet.

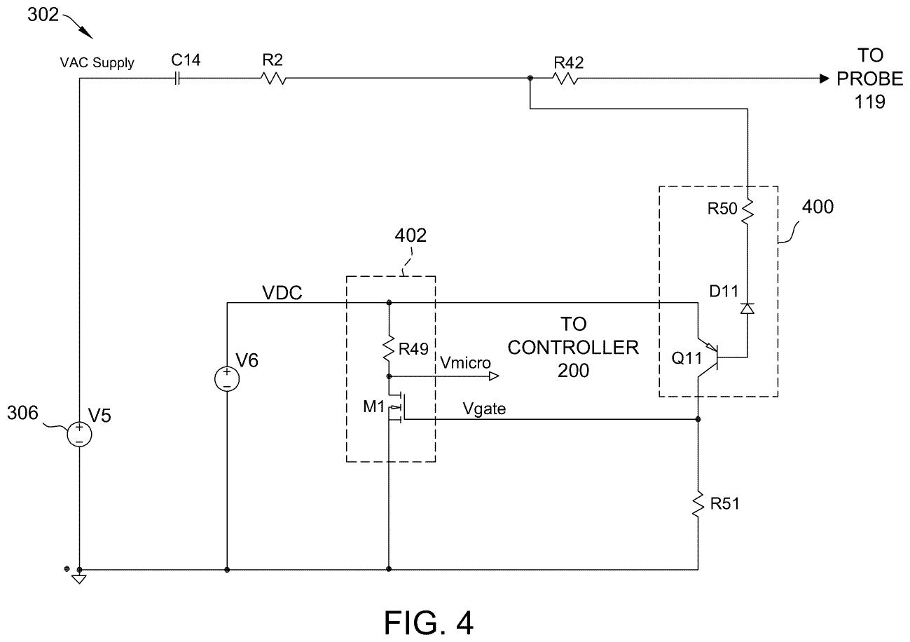

FIG. 4 is a circuit diagram of an example detector 302 for use in the flame probe assembly 300. The AC power 306 is coupled to a capacitance C14. The AC power 306 in this example is an AC voltage supply of nominal line frequency (50/60 Hz) at any suitable amplitude. In some embodiments, the AC voltage supply is the same as that which powers the controller 200. The capacitance C14 may be constructed using one or more components in series, or parallel. The AC supply is coupled to the flame probe 119 through the capacitance C14 and an additional electrical connection. In the example embodiment, the additional electrical connection includes the resistors R2 and R42. In other embodiments, the additional electrical connection may be any electrical component having any suitable impedance value.

A switching mechanism 400 is connected to the additional electrical connection. The switching mechanism 400 is configured to operate when voltage at the additional electrical connection is either negative, or positive, with respect to circuit ground. The example switching mechanism 400 includes a diode D11 to differentiate between negative or positive voltage at the additional electrical connection. Other embodiments may not use the diode D11. The switch mechanism 400 is connected to a DC voltage source V6. The DC voltage source V6 provides a DC voltage with an RMS value that is less than the AC supply 306. The switch mechanism 400 includes a high impedance resistor R50. High impedance is defined as greater than or equal to 1 MEGΩ, as measured at the line frequency of the AC power source 306. Other embodiments may use any other suitable high impedance component.

The switching mechanism 400 outputs a DC square wave voltage of varying pulse width (duration) across the resistor R51 every AC cycle. In other embodiments, the resistor R51 is omitted. The DC square wave output of the switching mechanism is connected to a shift circuit 402. The DC square wave voltage is inverted, or level shifted, by the shift circuit 402 and the inverted DC square wave voltage is output to the controller 200.

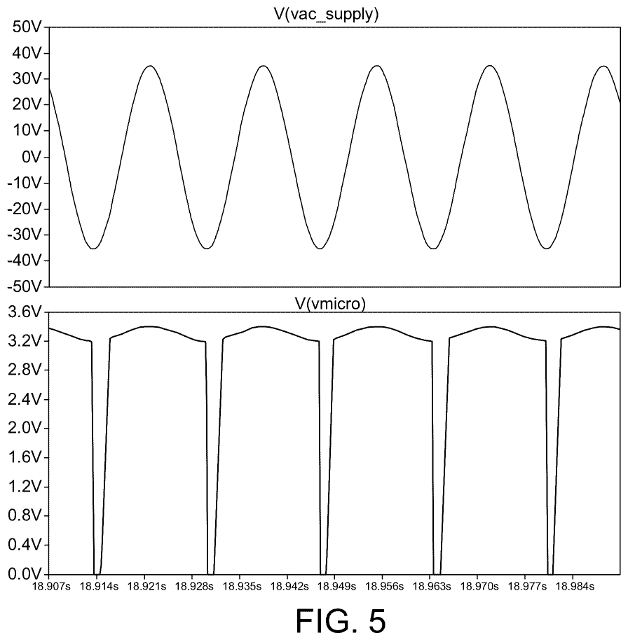

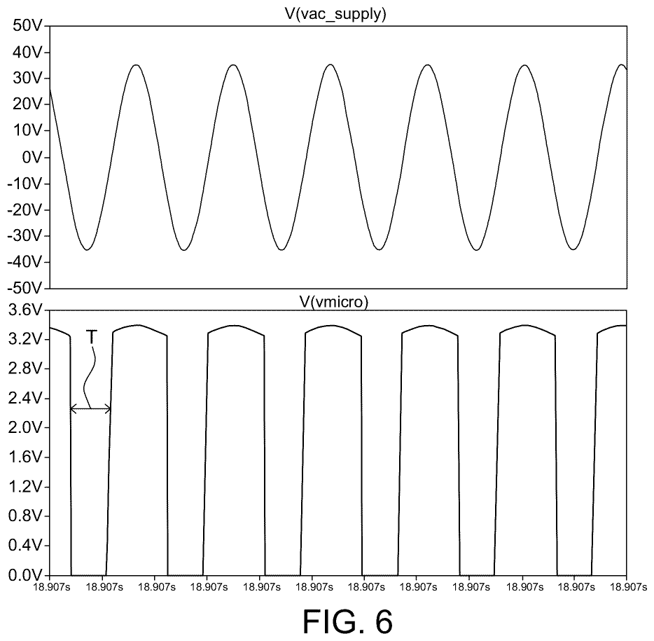

FIG. 5 is a graph of a simulated AC input from the AC power source 306 (at VAC_Supply in FIG. 4) and an output of the detector 302 (at Vmicro in FIG. 4) when there is no flame 304 on the main burner 108. FIG. 6 is a graph of a simulated AC input from the AC power source 306 (at VAC_Supply in FIG. 4) and an output of the detector 302 (at Vmicro in FIG. 4) when there is a flame 304 on the main burner 108. Because of the inversion of the DC square wave produced by the shift circuit 402, each pulse in FIGS. 5 and 6 is a drop from about 3.5 volts to 0 volts. As can be seen, when there is no flame (FIG. 5), the pulse width T of each pulse is relatively short, while when there is a flame (FIG. 6), the pulse width is noticeably longer. Thus, by determining the pulse width T of the pulses of the DC square wave and comparing the determined pulse width to one or more threshold value, the controller 200 can determine if a flame 304 is present on the main burner 108. Thus in this example, a pulse width less than about 2 msec could be used to indicate no flame, while a pulse width of greater than 5 msec could be used to indicate flame is present. Alternatively, a single threshold could be used and a pulse width less than 4 msec could indicate no flame and equal or more than 4 msec could indicate flame is present.

An additional or alternative measurement that can be used for determining, among other things, if a flame is present is variation in the pulse widths over time. When a flame is present, not only do the pulse widths change relative to when no flame is present, but the flame induces variation in the pulse widths over time. The variation is a signal type that does not appear to be able to be manipulated by component values or mimicked by any known system failure mode.

By monitoring the pulse widths, the variation, or a combination of the two, different characteristics of the flame can be determined. For example, Trial For Ignition (TFI) is an important step in the flame sense process. When attempting to light a flame on the main burner, gas is released and sparks are generated to ignite the gas (in a spark ignition system). When the gas successfully ignites, there is a high voltage explosion. Because the voltage on the flame probe at that moment far exceeds the voltage of the AC input supply, no current can flow in the detector 302. It will be temporarily prevented from generating any pulses until that explosive energy has dissipated. Because the pulses in the DC square wave occur at a fixed frequency, this ‘dead time’ can be seen in the DC square wave as a point at which one or more pulses appear to be missing. Thus, by detecting the absence of a pulse in the DC square wave when one is expected, the controller 200 can determine that the gas has successfully been ignited.

Other flame characteristics that may be determined based on the pulse widths, the variation, or a combination of the two may include burn quality of the flame (e.g., rich or lean), amount of carbon monoxide production, status of the flame probe (e.g., level of degradation), and the like.

This written description uses examples to disclose the invention, including the best mode, and also to enable any person skilled in the art to practice the invention, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A gas-powered furnace system comprising:
a combustion chamber for generating heat from combustion of gas;
a main burner for burning gas disposed in the combustion chamber;
a flame sensor assembly including:
a probe positioned proximate the main burner to couple an electric current to the main burner through a flame on the main burner and not to couple an electric current to the main burner when the flame is not present on the main burner, and
a detector coupled to the probe, the detector configured to receive an alternating current (AC) input, couple the AC input to the probe, and generate a variable pulse width direct current (DC) square wave output having a plurality of pulses; and
a controller connected to the flame sensor assembly, the controller including a processor and a memory, the controller programmed to:
control the main burner to selectively burn gas,
determine a pulse width of a pulse of the plurality of pulses of the variable pulse width DC square wave, and
determine based on the determined pulse width a characteristic of the flame on the main burner.

2. The gas-powered furnace system of claim 1, wherein the controller is programmed to control the main burner based at least in part on the determined characteristic of the flame on the main burner.

3. The gas-powered furnace system of claim 1, wherein the controller is programmed to control output information based at least in part on the determined characteristic of the flame on the main burner.

4. The gas-powered furnace system of claim 1, wherein the characteristic of the flame on the main burner determined by the controller comprises a presence or absence of the flame on the main burner.

5. The gas-powered furnace system of claim 1, wherein the controller is programmed to determine the pulse width of each pulse of the plurality of pulses of the variable pulse width DC square wave and store the determined pulse widths in the memory.

6. The gas-powered furnace system of claim 5, wherein the controller is programmed to determine the characteristic of the flame on the main burner based on the determined pulse widths stored in the memory.

7. The gas-powered furnace system of claim 5, wherein the controller is programmed to determine the characteristic of the flame on the main burner based on one or more differences between individual pulse widths of the determined pulse widths stored in the memory.

8. The gas-powered furnace system of claim 5, wherein the characteristic of the flame on the main burner determined by the controller comprises an ignition of the flame on the main burner based on an absence of at least one expected pulse of the plurality of pulses of the variable pulse width DC square wave.

9. The gas-powered furnace system of claim 1, wherein the detector is configured to generate the variable pulse width DC square wave output with one pulse for each cycle of the AC input.

10. The gas-powered furnace system of claim 1, wherein the controller is programmed to:
determine differences between pulse widths of the plurality of pulses of the of the variable pulse width DC square wave;
store an indication of the determined differences in the memory; and
determine the characteristic of the flame on the main burner based on the indication of the determined differences stored in the memory.

11. A gas-powered appliance comprising:
a main burner for burning gas;
a flame sensor assembly including:
a probe positioned proximate the main burner to couple an electric current to the main burner through a flame on the main burner and not to couple an electric current to the main burner when the flame is not present on the main burner, and
a detector coupled to the probe, the detector configured to receive an alternating current (AC) input, couple the AC input to the probe, and generate a variable pulse width direct current (DC) square wave output having a plurality of pulses; and
a controller connected to the flame sensor assembly, the controller including a processor and a memory, the controller programmed to:
control the main burner to burn gas,
determine a pulse width of a pulse of the plurality of pulses of the variable pulse width DC square wave, and
determine based on the determined pulse width a characteristic of the flame on the main burner.

12. The gas-powered appliance of claim 11, wherein the controller is programmed to control the main burner based at least in part on the determined characteristic of the flame on the main burner.

13. The gas-powered appliance of claim 11, wherein the controller is programmed to control output information based at least in part on the determined characteristic of the flame on the main burner.

14. The gas-powered appliance of claim 11, wherein the characteristic of the flame on the main burner determined by the controller comprises a presence or absence of the flame on the main burner.

15. The gas-powered appliance of claim 11, wherein the controller is programmed to determine the pulse width of each pulse of the plurality of pulses of the variable pulse width DC square wave and store the determined pulse widths in the memory.

16. The gas-powered appliance of claim 15, wherein the controller is programmed to determine the characteristic of the flame on the main burner based on the determined pulse widths stored in the memory.

17. The gas-powered appliance of claim 15, wherein the controller is programmed to determine the characteristic of the flame on the main burner based on one or more differences between individual pulse widths of the determined pulse widths stored in the memory.

18. The gas-powered appliance of claim 15, wherein the characteristic of the flame on the main burner determined by the controller comprises an ignition of the flame on the main burner based on an absence of at least one expected pulse of the plurality of pulses of the variable pulse width DC square wave.

19. The gas-powered appliance of claim 11, wherein the detector is configured to generate the variable pulse width DC square wave output with one pulse for each cycle of the AC input.

20. The gas-powered appliance of claim 11, wherein the controller is programmed to:
determine differences between pulse widths of the plurality of pulses of the variable pulse width DC square wave;
store an indication of the determined differences in the memory; and
determine the characteristic of the flame on the main burner based on the indication of the determined differences stored in the memory.
